(19) United States
(12) Patent Application Publication
(10) Pub. No.: US 2020/0153065 A1
(43) Pub. Date: May 14, 2020

(54) ACCUMULATOR ARRANGEMENT

(71) Applicant: Mahle International GmbH, Stuttgart (DE)

(72) Inventors: Ingo Haeusler, Esslingen (DE); Thomas Kalmbach, Stuttgart (DE); Ruediger Knauss, Kernen i.R. (DE); Peter Nowak, Stuttgart (DE); Karl-Ulrich Schmid-Walderich, Tuebingen (DE); Alireza Mirsadraee, Ludwigsburg (DE)

(21) Appl. No.: 16/680,441

(22) Filed: Nov. 11, 2019

(30) Foreign Application Priority Data
Nov. 12, 2018 (DE) 10 2018 219 249.9

(51) Int. Cl. H01M 10/6568; H01M 10/625

(52) U.S. Cl. CPC H01M 10/6568; H01M 2220/20; H01M 10/625

(57) ABSTRACT

An accumulator arrangement for a hybrid or electric vehicle may include a plurality of battery cells stacked in a stacking direction to form at least one battery block, a housing having at least one part interior in which the at least one battery block is arranged, and a cooling device through which a cooling liquid is flowable for cooling the at least one battery block. In the at least one part interior, the cooling liquid may be at least one of flowable about a plurality sides of the at least one battery block and/or flowable through the at least one battery block, such that the at least one part interior defines a portion of the cooling device. At least one passage structure body for displacing the cooling liquid is arranged in the at least one part interior at least in regions about the at least one battery block.

### CROSS-REFERENCE TO RELATED APPLICATIONS

This application claims priority to German Patent Application No. DE 10 2018 219 249.9, filed on Nov. 12, 2018, the contents of which is hereby incorporated by reference in its entirety.

### TECHNICAL FIELD

The invention relates to an accumulator arrangement for a hybrid or electric vehicle.

### BACKGROUND

Accumulator arrangements for hybrid or electric vehicles are already known from the prior art. There, multiple battery cells are set into battery modules and arranged in a common housing. For this purpose, the battery cells are temperature-controlled to maintain their function. In particular in the case of accumulator arrangements with a high performance density and a demanded quick-charge capability, an efficient cooling is indispensible. Usually, the battery cells in a battery module are cooled by cooling plates which are in a heat-transferring contact with the individual batter cells. The cooling plates are flowed through by a liquid coolant and thereby cooled. Thus, there is an indirect cooling of the battery cells since these are not in a direct heat-transferring contact with the coolant. Because of the limited heat transfer surfaces between the cooling plates and the battery cells, the heat transfer that can be achieved is uneven compared with a direct cooling. This leads to a reduction of the performance and the lifespan of the accumulator arrangement. Furthermore, accumulator arrangement with a direct air cooling are known from WO 2017/026312 A1. There, the air flows directly about the battery cells which are thereby cooled. However, because of the air characteristics, a direct air cooling has a lower efficiency than a cooling with a liquid coolant. This disadvantage is reduced by using large air volumes. Disadvantageously, the concept of an air cooling of the battery cells cannot be easily transferred to a liquid coolant and is realised to date only for individual regions of the battery cells.

### SUMMARY

The object of the invention therefore is to state an improved or at least alternative embodiment for an accumulator arrangement of the generic type, which with the described disadvantages are overcome.

According to the invention, this object is solved through the subject matter of the independent claim(s). Advantageous embodiments are subject of the dependent claim(s).

The present invention is based on the general idea of making possible a direct cooling of battery cells with a cooling liquid by a reduction of a flowed-through volume in the accumulator arrangement. An accumulator arrangement is provided for a hybrid or electric vehicle and comprises multiple battery cells, which in the stacking direction are stacked to form at least one battery block. Furthermore, the accumulator arrangement comprises a housing having at least one part interior, in which the at least one battery block is arranged. The accumulator arrangement also comprises a cooling device that can be flowed through by a cooling liquid for cooling the battery cells in the at least one battery block. According to the invention, the at least one battery block in the respective part interior can be flowed about by the cooling liquid on multiple sides, in particular all sides or can be flowed about by the cooling liquid on multiple sides, in particular all sides and flowed through at least partly, so that the part interior forms a part of the cooling device that can be flowed through by the cooling liquid. In addition, the accumulator arrangement comprises at least one passage structure for displacing the cooling liquid, which is arranged in the part interior at least in regions about the at least one battery block.

The at least one battery block is arranged in the part interior of the housing, wherein a wall of the housing limiting the part interior and the at least one battery block within the part interior are directly impinged by the cooling liquid. By way of this, the at least one battery block can be efficiently cooled on multiple sides, preferentially all sides. Appropriately, the cooling liquid is dielectric, so that no impairment of the function of the at least one battery block flowed about and flowed through occurs. Here, the passage structure body partly fills out hollow spaces that are present in the part interior so that the volume of the cooling liquid in the part interior can be reduced. Because of this, the necessary volume for cooling the accumulator arrangement and consequently the weight of the same can be reduced on the whole. By a reduction of the weight the required energy for driving the hybrid or electric vehicle can be reduced. Furthermore, the volume of the cooling liquid is also reduced in a maintenance event, so that on the one hand the maintenance time for removing the cooling liquid is shortened and on the other hand the material and disposal expenditure are minimised. Furthermore, the accumulator arrangement also has further economical and ecological advantages. Furthermore, dead volumes in the part interior that are not continuously flowed through can be connected and thereby a damming-up of the cooling liquid in the part interior prevented. Through the at least one passage structure body, an even profile of the temperature of the cooling liquid can be achieved in the part interior. Furthermore, the cooling liquid can be conducted through the passage structure body in the part interior about the at least one battery block so that the cooling liquid can be evenly distributed in the part interior.

Advantageously it can be provided that the housing has a cover and a tub-shaped receiving part. There, the at least one part interior is formed in the receiving part and closed with the at least one cover in a fluid-tight manner. The passage structure body is then formed within the at least one part interior in one piece with the receiving part or with the at least one cover. There, the receiving part and/or the cover and/or the passage structure body can be formed from plastic in an injection moulding method or in a pressing method.

In a further development of the accumulator arrangement it is provided that the passage structure body comprises two passage walls located opposite one another. Then, the passage walls are arranged in the respective part interior in each case between a housing wall and the at least one battery block and extend parallel to the stacking direction. There, the respective housing wall forms an integral part of a wall of the housing which limits the at least one part interior. The passage walls between the respective housing wall and the respective battery block extend in the stacking direction and accordingly are arranged facing lateral surfaces of the individual battery cells in the at least one battery block.

Additionally it can be provided that in the one passage wall at least in certain regions a distribution passage and in the other passage wall, at least in certain regions, a collection passage are formed. The distribution passage and the collection passage are fluidically connected to a region of the part interior round about the battery preferentially through openings penetrating the passage wall. As will be explained further down below, the distribution passage and the collection passage can be formed in the respective passage wall completely or in certain regions. The distribution passage and the collection passage are appropriately formed in the respective passage wall facing away from the at least one battery block. Thus, the distribution passage and the collection passage for example can be formed by a recess in the respective passage wall each oriented in the stacking direction, which passage is closed by the respective housing wall. The respective openings can then lead out of the respective recess to the at least one battery block. By way of this, the distribution passage and the collection passage—which face away from the at least one battery block—can then be fluidically connected to the part interior round about the same. Advantageously, the openings in the distribution passage and in the collection passage can be distributed in the stacking direction in such a manner that the cooling liquid exits the distribution passage in the stacking direction evenly distributed. Because of this, the individual battery cells of the at least one battery block can be evenly cooled independently of their position in the battery block. Accordingly, the openings of the collection passage can make possible an even discharging of the cooling liquid. A wall of the housing and the battery block are directly impinged by the cooling liquid so that any leakage from the distribution passage or from the collection passage within the part interior is harmless. Consequently, the distribution passage and the collection passage to a region of the part interior round about the battery block need not be additionally sealed.

Advantageously it can be provided that the distribution passage is formed in certain regions in the receiving part within the at least one part interior and in certain regions in the at least one cover. In addition, the collection passage can be formed in certain regions in the receiving part within the at least one part interior and in certain regions in the at least one cover. By way of this, the distribution passage and the collection passage are then completely formed by the closing of the part interior with the cover. A prerequisite here is that the passage structure body within the at least one part interior is formed in one piece with the receiving part or with the at least one cover. In particular, the production of the receiving part and of the cover can be simplified through this advantageous configuration. These can be formed for example from plastic in an injection moulding method or in a pressing method.

In a further development of the passage structure body it is provided that the two passage walls in the part interior define a first flow path for a first part flow of the cooling liquid and a second flow path for a second part flow of the cooling liquid. The first flow path then leads transversely to the stacking direction from the distribution passage to the collection passage in a first circulating direction about the battery block and the second flow path leads transversely to the stacking direction from the distribution passage to the collection passage in a second circulating direction opposite to the first circulating direction about the battery block. The two part flows of the cooling liquid are preferentially identical in size so that the at least one battery block is evenly flowed about on all sides, preferentially on multiple sides and if required can be additionally flowed through and is efficiently cooled. When the distribution passage and the collection passage in the respective passage wall are fluidically connected to a region of the part interior round about the battery block by the openings, these can be evenly distributed in the stacking direction. By way of this, the cooling liquid can be evenly fed out of the distribution passage to the at least one battery block and accordingly evenly fed from the at least one battery block into the collection passage.

Advantageously, multiple fluid guiding ribs can be formed on the respective passage wall facing the at least one battery block, which are preferentially oriented transversely to the stacking direction and can guide a part flow about the battery block. As already explained above, the respective passage walls face lateral surfaces of the respective battery cells so that fluid guide ribs can guide the cooling liquid about the battery block on the lateral surfaces of the individual battery cells. In particular, the individual battery cells in the at least one battery block can thereby be cooled efficiently.

In order to cool the individual battery cells in the at least one battery block independently of their position in the at least one battery block, the flow cross section of the distribution passage can become smaller in the flow direction away from an inlet and/or the flow cross section of the collection passage can become larger in the flow direction towards an outlet. Then, the distribution passage and/or the collection passage are cuneiform or funnel-shaped. Advantageously, the cooling liquid can thereby be evenly distributed in the stacking direction towards the battery block regardless of the pressure drop in the distribution passage. Accordingly, the cooling liquid can be evenly fed to the collection passage. In particular, an even flow about the individual cells independently of their position in the battery block can be achieved in this manner and the individual battery cells thereby cooled effectively.

Advantageously it can be provided that on the at least one passage structure body and/or on the housing a framework-like stiffening structure that cannot be flowed through by the cooling liquid is formed. By way of the stiffening structure, the passage structure body and/or the housing can be stiffened. On the housing and/or on the passage structure body, at least one displacement region with a contour that is closed in certain regions can be integrally formed, which projects into the at least one part interior and displaces the cooling liquid from the part interior. The displacement region can be formed for example through a pocket projecting into the part interior, in which located outside a stiffening structure is formed. Appropriately, the stiffening structure cannot then be flowed through by the cooling liquid and additionally stiffens the housing and/or the passage structure body.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIGS. 1 and 2 show views of an accumulator arrangement according to the invention in a first embodiment;

FIGS. 3 and 4 show views of the accumulator arrangement according to the invention in a second embodiment;

FIG. 5 shows a view of one of the covers of the accumulator arrangement in the second embodiment.

### DETAILED DESCRIPTION

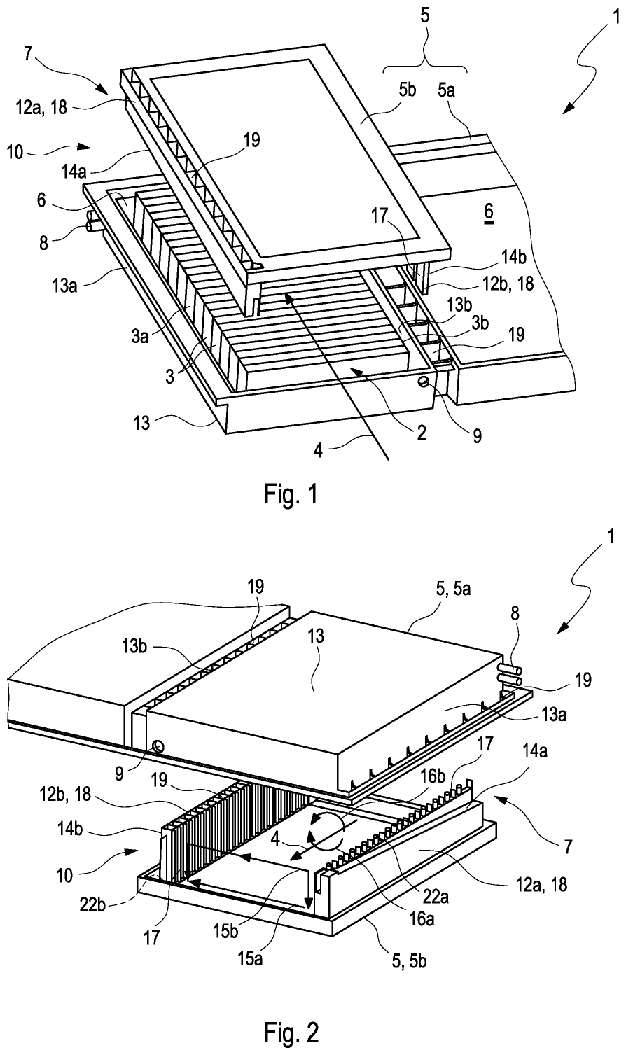

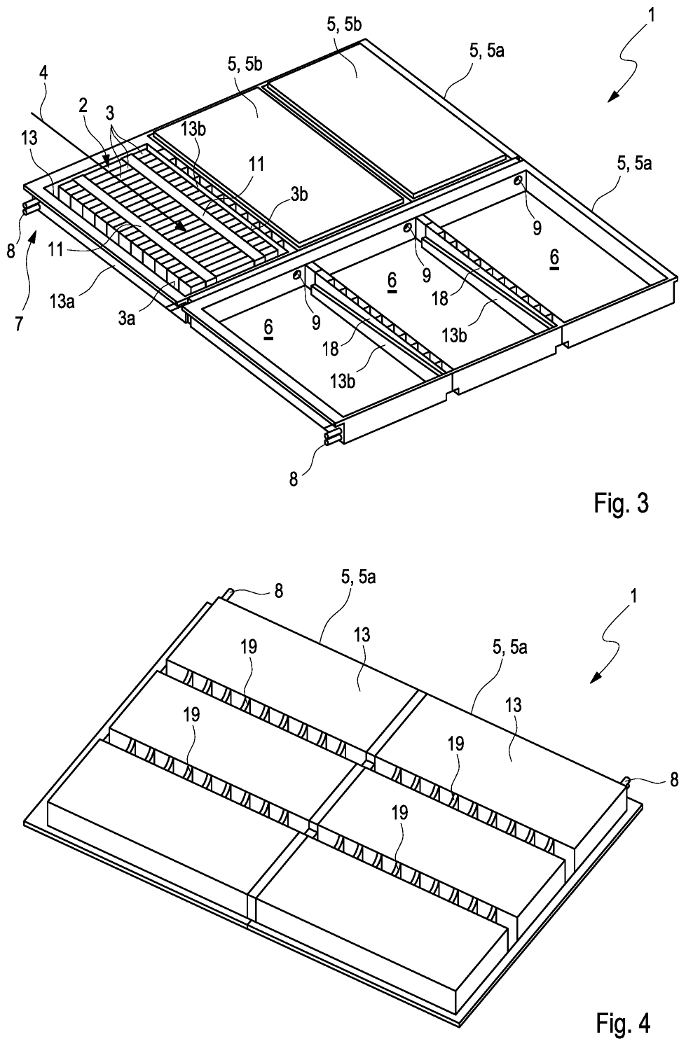

FIG. 1 and FIG. 2 show views of an accumulator arrangement 1 according to the invention in a first embodiment from opposite sides. The accumulator arrangement 1 comprises multiple battery blocks 2—only one shown here—of multiple battery cells 3. The battery cells 3 are stacked in the stacking direction 4 to form the respective battery block 2 and can be clamped to one another by way of two clamping straps 11—such as shown for example in FIG. 3. The accumulator arrangement 1, furthermore, comprises a housing 5 with a tub-like receiving part 5a and with multiple covers 5b. In the receiving part 5a, individual part interiors 6 are formed, in which the respective battery blocks 2 are individually arranged. The individual part interiors 6 are closed with the respective cover 5b in a fluid-tight manner.

For cooling the respective battery blocks 2, the accumulator arrangement 1 comprises a cooling device 7 that can be flowed through by a cooling liquid. The cooling liquid flows from an inlet 8 of the part interior 6 to an outlet 9 of the part interior 6 through the respective part interior 6. The inlet 8 is formed through a passage opening in the receiving part 5a and appropriately leads from outside into the respective part interior 6. In the same way, the outlet 9 is formed through a passage opening in the receiving part 5a and leads out of the respective part interior 6 to the outside. The respective battery block 2 is thus arranged in the respective part interior 6 so that it can be flowed about on all sides and flowed through by the cooling liquid and is directly impinged by the cooling liquid. Appropriately, the cooling liquid is dielectric, so that the function of the accumulator arrangement 1 is not impaired at all. Thus, the cooling device 7 is formed by the multiple inlets 8, the multiple outlets 9 and the part interiors 6 that can be flowed through. It is to be understood that the individual inlets 8 and the individual outlets 9 outside the respective part interiors 6 are fluidically connected to one another in a suitable manner, so that the multiple part interiors 6 of the accumulator arrangement 1 can be flowed through by the cooling liquid.

In addition, the accumulator arrangement 1 comprises multiple passage structure bodies 10—only one shown here—, which are assigned to the respective part interior 6. In the first embodiment of the accumulator arrangement 1, the respective passage structure bodies 10 are integrally formed on the respective covers 5b or formed in one piece with these. The respective passage structure body 10 is formed through passage walls 12a and 12b located opposite one another. The passage walls 12a and 12b are each arranged in the respective part interior 6 between a housing wall 13a and 13b and the respective battery block 6 and extend parallel to the stacking direction 4. The respective housing wall 13a and 13b forms an integral part of a wall 13 of the housing 5, which limits the at least one part interior 6 towards the outside. The passage walls 12a and 12b are thus arranged facing lateral surfaces 3a and 3b of the individual battery cells 3 of the respective battery block 2.

In the passage wall 12a, an open cuneiform distribution passage 14a facing away from the respective battery block 2 is formed, which is closed by the housing wall 13a. The distribution passage 14a is fluidically connected through multiple openings 22a with a region of the part interior 6 round about the respective battery block 2. Correspondingly, an open cuneiform collection passage 14b facing away from the respective battery block 2 is formed in the passage wall 12b. The collection passage 14b is closed through the housing wall 13b and through the openings 22b fluidically connected to a region of the part interior 6 surrounding the respective battery block 2. There, the openings 22a and 22b are evenly distributed in the stacking direction 4 so that the cooling liquid can exit evenly distributed in the stacking direction 4 from the distribution passage 14a and flow, evenly distributed in the stacking direction 4, into the collection passage 14b. By way of the cuneiform shape of the distribution passage 14a and of the collection passage 14b, an even flow through the respective battery block 2 is additionally made possible.

In the respective part interior 6, the two passage walls 12a and 12b form a first flow path 15a for a first part flow of the cooling liquid and a second flow path 15b for a second part flow of the cooling liquid. Here, the cooling liquid flows from the inlet 8 into the distribution passage 14a and exits from the openings 22a. From here, the first part flow flows in the first flow path 15a, which leads transversely to the stacking direction 4 from the distribution passage 14a to the collection passage 14b in a first circulating direction 16a about the battery block 2. The second part flow flows in the second flow path 15b, which leads from the distribution passage 14a to the collection passage 14b transversely to the stacking direction 4 in a second circulating direction 16b about the battery block 2. At the collection passage 14b, the two part flows of the cooling liquid flow together through the openings 22b into the collection passage 14b and then through the outlet 9 out of the part interior 6. On the respective passage walls 12a and 12b, multiple fluid guide ribs 17 facing the respective battery block 2 which are oriented transversely to the stacking direction 4 are additionally formed, which support the flow-through of liquid in the respective flow path 15a and 15b and reduce the volume of the cooling liquid.

On the respective passage structure body 10, the respective passage wall 12a and 12b is designed in the form of a displacement region 18. In the respective displacement region 18, a framework-like stiffening structure 19 is additionally formed. Through the displacement region 18, the cooling liquid can be displaced out of the part interior 6 so that no dead volumes that cannot be flowed through by the cooling liquid or only poorly so are created in the part interior 6. The stiffening structure 19 stiffens the respective passage wall 12a and 12b without unnecessarily increasing the weight of the passage structure body 10 or of the cover 5b. A further stiffening structure 19 is formed on the receiving part 5a of the housing 5, additionally stiffening the same.

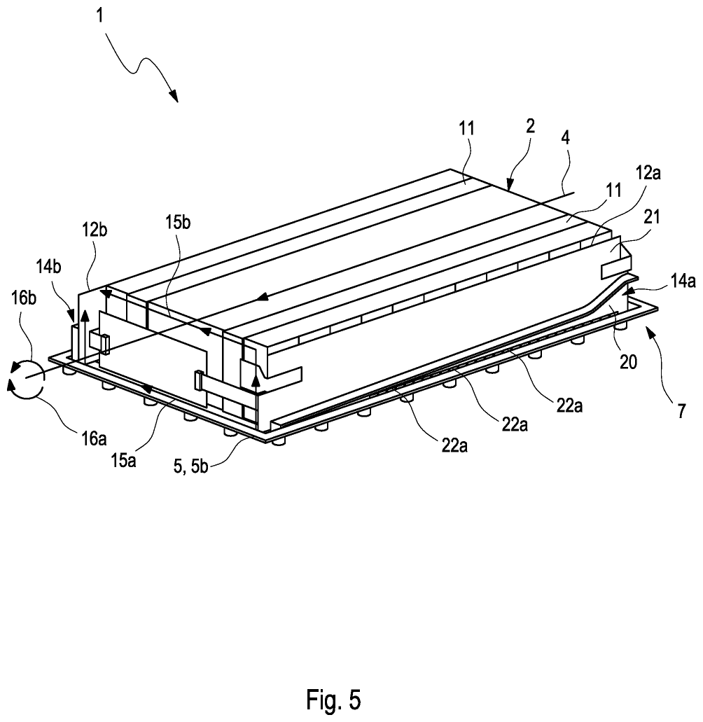

FIG. 3 and FIG. 4 show views of the accumulator arrangement 1 according to the invention in a second embodiment of opposite sides. FIG. 5 shows a view of the cover 5b of the accumulator arrangement 1 with the battery block 2 fixed to the same. In the following, the differences between the accumulator arrangements 1 in the two embodiments is discussed separately. As for the rest, the accumulator arrangement 1 shown here corresponds to the accumulator arrangement 1 shown in FIG. 1 and FIG. 2.

Here, deviating from the first embodiment of the accumulator arrangement 1, the housing 5 is formed by two receiving parts 5a and the multiple covers 5b. Furthermore, the distribution passage 14a and the collecting passage 14b are delimited towards the respective housing wall 13a and 13b by a moulding 20 on the respective passage wall 12a and 12b. By way of this, the respective passage wall 12a and 12b is subdivided into the distribution passage 14a or the collection passage 14b and an empty region 21. On the respective moulding 20 in the empty region 21, the displacement region 18 is arranged in each case, which is moulded in the part interior 6 on the respective housing wall 13a and 13b. By way of this, a dead volume that is not continuously flowed through and created by the respective empty region 21 can be reduced. Appropriately, the outer contour of the respective displacement region 18 is complementarily moulded to the respective empty region 21. The respective displacement region 18, facing away from the part interior 6, is stiffened by the reinforcement structure 19.

In summary, the respective battery block 2 can be efficiently and evenly cooled in the accumulator arrangement 1 according to the invention. Furthermore, dead volumes in the accumulator arrangement 1 that are not flowed through continuously can be excluded and uneven profile of the temperature of the cooling liquid in the part interior 6 achieved. Furthermore, the volume of the cooling liquid in the accumulator arrangement 1 can be reduced and the weight of the same advantageously reduced by way of this.

1. An accumulator arrangement for a hybrid or electric vehicle, comprising:
a plurality of battery cells stacked in a stacking direction to form at least one battery block;
a housing having at least one part interior in which the at least one battery block is arranged;
a cooling device through which a cooling liquid is flowable for cooling the plurality of battery cells in the at least one battery block;
the at least one battery block having a plurality of sides;
wherein, in the at least one part interior, the cooling liquid is at least one of (i) flowable about the plurality of sides of the at least one battery block and (ii) flowable about the plurality sides of the at least one battery block and flowable at least partly through the at least one battery block, such that the at least one part interior defines a portion of the cooling device through which the cooling liquid is flowable; and
wherein at least one passage structure body for displacing the cooling liquid is arranged in the at least one part interior at least in regions about the at least one battery block.

2. The accumulator arrangement according to claim 1, wherein:
the housing includes at least one cover and at least one tub-like receiving part, the at least one part interior formed in the at least one receiving part and closed via the at least one cover in a fluid-tight manner; and
the at least one passage structure body within the at least one part interior and at least one of (i) the at least one receiving part and (ii) the at least one cover, are provided as a single, integral piece.

3. The accumulator arrangement according to claim 1, wherein the at least one passage structure body includes two passage walls disposed opposite one another and extending parallel to the stacking direction, the two passage walls disposed in the at least one part interior between a housing wall and the at least one battery block.

4. The accumulator arrangement according to claim 3, wherein a distribution passage is disposed at least in regions of a first passage wall of the two passage walls, and a collection passage is disposed at least in regions of a second passage wall of the two passage walls, the distribution passage and the collection passage each fluidically connected to a region of the at least one part interior around the at least one battery block.

5. The accumulator arrangement according to claim 4, wherein:
the housing includes at least one cover and at least one tub-like receiving part, the at least one part interior formed in the at least one receiving part and closed via the at least one cover in a fluid-tight manner;
the at least one passage structure body within the at least one part interior and at least one of (i) the at least one receiving part and (ii) the at least one cover, are provided as a single, integral piece;
at least one of:
the distribution passage is formed in regions in the at least one receiving part within the at least one part interior and in regions in the at least one cover such that the distribution passage is completely defined via closing the at least one part interior with the at least one cover; and
the collection passage is formed in regions in the at least one receiving part within the at least one part interior and in regions in the at least one cover such that the collection passage is completely defined via closing the at least one part interior with the at least one cover.

6. The accumulator arrangement according to claim 4, wherein:
the two passage walls in the at least one part interior define a first flow path for a first part flow of the cooling liquid and a second flow path for a second part flow of the cooling liquid;
the first flow path extends about the at least one battery block transversely to the stacking direction from the distribution passage to the collection passage in a first circulating direction; and
the second flow path extends about the at least one battery block transversely to the stacking direction from the distribution passage to the collection passage in a second circulating direction opposite the first circulating direction.

7. The accumulator arrangement according to claim 4, further comprising a plurality of fluid guide ribs disposed on at least one of the two passage walls facing the at least one battery block.

8. The accumulator arrangement according to claim 4, wherein at least one of:
a flow cross section of the distribution passage diminishes in size in a flow direction away from an inlet such that the distribution passage is at least one of cuneiform and funnel-shaped; and
a flow cross section of the collection passage increases in size in the flow direction towards an outlet such that the collection passage is at least one of cuneiform and funnel-shaped.

9. The accumulator arrangement according to claim 1, further comprising a framework-like stiffening structure disposed on at least one of the at least one passage structure body and the housing, wherein the stiffening structure cannot be flowed through by the cooling liquid.

10. The accumulator arrangement according to claim 1, wherein at least one displacement region with a closed contour is integrally formed on at least one of the at least one passage structure body and the housing, wherein the at least one displacement region projects into the at least one part interior displacing cooling liquid out of the at least one part interior.

11. The accumulator arrangement according to claim 4, wherein:
the housing includes at least one cover and at least one tub-like receiving part, the at least one part interior formed in the at least one receiving part and closed via the at least one cover in a fluid-tight manner;
the at least one passage structure body within the at least one part interior and at least one of (i) the at least one receiving part and (ii) the at least one cover, are provided as a single, integral piece;
the distribution passage is formed in regions in the at least one receiving part within the at least one part interior and in regions in the at least one cover such that the distribution passage is completely defined via closing the at least one part interior with the at least one cover; and
the collection passage is formed in regions in the at least one receiving part within the at least one part interior and in regions in the at least one cover such that the collection passage is completely defined via closing the at least one part interior with the at least one cover.

12. The accumulator arrangement according to claim 4, wherein:
the distribution passage is fluidically connected to the at least one part interior via at least one first opening penetrating the first passage wall; and
the collection passage is fluidically connected to the at least one part interior via at least one second opening penetrating the second passage wall.

13. The accumulator arrangement according to claim 7, wherein the plurality of fluid guide ribs are oriented transversely to the stacking direction and configured to guide at least some flow of cooling liquid about the at least one battery block.

14. An accumulator arrangement for a hybrid or electric vehicle, comprising:
a plurality of battery cells stacked in a stacking direction to form at least one battery block;
a housing having at least one part interior in which the at least one battery block is arranged;
a cooling device through which a cooling liquid is flowable for cooling the plurality of battery cells in the at least one battery block;
wherein, in the at least one part interior, the cooling liquid is flowable about a plurality sides of the at least one battery block and flowable at least partly through the at least one battery block, such that the at least one part interior defines a portion of the cooling device through which the cooling liquid is flowable; and
wherein at least one passage structure body for displacing the cooling liquid is arranged in the at least one part interior at least in regions about the at least one battery block.

15. The accumulator arrangement according to claim 14, wherein:
the housing includes at least one cover and at least one tub-like receiving part, the at least one part interior formed in the at least one receiving part and closed via the at least one cover in a fluid-tight manner; and
the at least one passage structure body within the at least one part interior and at least one of (i) the at least one receiving part and (ii) the at least one cover, are provided as a single, integral piece.

16. The accumulator arrangement according to claim 15, wherein the at least one passage structure body includes two passage walls disposed opposite one another and extending parallel to the stacking direction, the two passage walls disposed in the at least one part interior between a housing wall and the at least one battery block.

17. The accumulator arrangement according to claim 16, wherein a distribution passage is disposed at least in regions of a first passage wall of the two passage walls, and a collection passage is disposed at least in regions of a second passage wall of the two passage walls, the distribution passage and the collection passage each fluidically connected to a region of the at least one part interior around the at least one battery block.

18. The accumulator arrangement according to claim 17, wherein:
a flow cross section of the distribution passage diminishes in size in a flow direction away from an inlet such that the distribution passage is at least one of cuneiform and funnel-shaped; and
a flow cross section of the collection passage increases in size in the flow direction towards an outlet such that the collection passage is at least one of cuneiform and funnel-shaped.

19. The accumulator arrangement according to claim 14, further comprising a framework-like stiffening structure disposed on at least one of the at least one passage structure body and the housing, wherein the stiffening structure cannot be flowed through by the cooling liquid.

20. The accumulator arrangement according to claim 14, wherein at least one displacement region with a closed contour is integrally formed on at least one of the at least one passage structure body and the housing, wherein the at least one displacement region projects into the at least one part interior displacing cooling liquid out of the at least one part interior.
